(19) United States
(12) Patent Application Publication
(10) Pub. No.: US 2015/0356413 A1
(43) Pub. Date: Dec. 10, 2015

(54) PLANT CONTROL DEVICE

(71) Applicant: Masanori SHIMADA, Aichi (JP)

(72) Inventor: Masanori SHIMADA, Susono-shi, Shizuoka-ken (JP)

(73) Assignee: TOYOTA JIDOSHA KABUSHIKI KAISHA, Toyota-shi, Aichi-ken (JP)

(21) Appl. No.: 14/760,847

(22) PCT Filed: Jan. 17, 2013
(86) PCT No.: PCT/JP2013/050811

§ 371 Date: Jul. 14, 2015

(51) Int. Cl. G06N 5/02; G05B 15/02

(52) U.S. Cl. CPC G06N 5/02; G05B 15/02

(57) ABSTRACT

According to the plant control device of this invention, based on a modified target value candidate of a control output, a reference governor uses a prediction model in which a closed loop system including a plant and a feedback controller are modeled to sequentially calculate, across a finite prediction horizon, a predicted value of state quantities of a plant including a specific state quantity on which a constraint is imposed. At such time, if a predicted value of a specific state quantity relating to a certain modified target value candidate conflicts with a constraint, the reference governor excludes the modified target value candidate from candidates for a final modified target value. Thus, the computational load required to modify a target value of a control output is decreased while ensuring the satisfiability of a constraint.

### TECHNICAL FIELD

The present invention relates to a control device for a plant, and more particularly relates to a control device that modifies a target value of a control output of a plant using a reference governor so that a constraint imposed on a state quantity of the plant is satisfied.

### BACKGROUND ART

A common plant control device is configured so that, when a target value relating to a control output of the plant is provided, the plant control device determines a control input of the plant by feedback control so that the relevant control output is caused to track the target value. However, in the actual control of a plant, there are many cases in which a variety of constraints with respect to the machinery or control exist in relation to state quantities of the plant. If those constraints are not satisfied there is a possibility that the machinery will be damaged or the control performance will deteriorate. Similarly to the trackability with respect to the target value of a control output, satisfiability of constraints is one of the important types of performance required with respect to control of a plant.

A reference governor is one effective means for satisfying the aforementioned requirement. A reference governor is equipped with a prediction model in which a closed loop system (feedback control system) that includes the plant that is the control object and a feedback controller are modeled. The reference governor uses the prediction model to predict a future value of a state quantity on which a constraint is imposed. The reference governor then modifies a target value of a controlled variable of the plant based on the predicted value of the state quantity and the constraint imposed thereon.

The prior art disclosed in Patent Literature 1 that is mentioned below can be mentioned as one example of the prior art in which a reference governor is applied to control of a plant. The aforementioned prior art relates to controlling the tensile force of rolled material in a multi-stage rolling mill. According to the prior art disclosed in Patent Literature 1, target raceway data in which temporal changes in the tensile force of the rolled material are defined is calculated in advance by a reference governor, and the tensile force of the rolled material is controlled based on a deviation between the actual value of the tensile force of the rolled material and the target raceway data.

In the invention disclosed in the above described official gazette, offline calculation is performed by a reference governor. Since a target value for the tensile force of the rolled material in the multi-stage rolling mill is provided in advance, modification of the target value by the reference governor can be performed offline. However, depending on the kind of plant, there are cases where online calculation and not offline calculation is required. An internal combustion engine that is used as a power unit in a vehicle is one kind of such a plant. In an internal combustion engine, because target values are constantly changing in accordance with the operating conditions, modification of target values by online calculation is required to satisfy constraints that are imposed on state quantities. However, because online calculations performed by a reference governor require a large amount of computation, a very large computational load is placed on a control device when online calculation by a reference governor is implemented using the control device.

### CITATION LIST

### Patent Literature

Patent Literature 1: Japanese Patent Laid-Open No. 2010-253501

### SUMMARY OF INVENTION

The present invention has been made in consideration of the above-described problem, and an object of the present invention is to reduce the computational load of a control device when modifying a target value of a control output using a reference governor so that a constraint imposed on a state quantity of a plant is satisfied.

A plant control device according to the present invention includes a feedback controller and a reference governor. The feedback controller is configured to determine a control input of a plant by feedback control so that a control output of the plant approaches a target value. There is no limitation with respect to the type or configuration of the plant that is a control object. The reference governor is configured to modify a target value that is provided to the feedback controller.

The reference governor can execute at least prediction model calculation processing, evaluation function calculation processing, and modified target value determination processing. According to the prediction model calculation processing, predicted values of state quantities of the plant that include a specific state quantity on which a constraint is imposed are sequentially calculated across a finite prediction horizon using a prediction model in which a closed loop system including the plant and the feedback controller is modeled based on a modified target value candidate for a control output. According to the evaluation function calculation processing, calculation of an evaluation value of the modified target value candidate is performed using a previously defined evaluation function based on a calculation result obtained by the prediction model calculation. According to the modified target value determination processing, the prediction model calculation processing and the evaluation function calculation processing are executed with respect to a plurality of modified target value candidates, and a final modified target value is determined based on respective evaluation values of the plurality of modified target value candidates.

According to the plant control device of the present invention, in a case where a predicted value of the specific state quantity that is predicted by prediction model calculation processing that relates to a certain modified target value candidate conflicts with a constraint, the reference governor excludes the certain modified target value candidate from candidates for a final modified target value. By equipping the reference governor with this function, the computational load that is necessary for modification of a target value by the reference governor is reduced.

In addition, in a case where a predicted value of the specific state quantity conflicts with a constraint during performance of prediction model calculation processing relating to a certain modified target value candidate, the reference governor may cancel remaining calculations of the prediction model calculation processing relating to the certain modified target value candidate. By also equipping the reference governor with this function, unnecessary prediction model calculation processing is aborted during the course of the processing, and the computational load that is necessary for modification of a target value is further reduced by a corresponding amount. Note that, in the prediction model calculation processing executed by the reference governor, a predicted value of the state quantity may be calculated discretely at a prediction cycle that is previously set. In this case, according to the above described functions, when a predicted value of the specific state quantity conflicts with a constraint at a discrete time point during a period from an initial discrete time point to a final discrete time point in prediction model calculation processing relating to a certain modified target value candidate, calculation of a predicted value of the state quantity at remaining discrete time points is cancelled.

According to the evaluation function calculation processing executed by the reference governor, an evaluation function may be used that gives a progressively favorable evaluation value as a difference between a predicted value of the control output at respective discrete time points calculated by the prediction model calculation processing and an original target value of the control output decreases. Further, according to the modified target value determination processing executed by the reference governor, a modified target value candidate for which the evaluation value is a most favorable value may be determined to be a final modified target value.

According to the modified target value determination processing executed by the reference governor, the modified target value candidate may be updated in accordance with a previously defined updating rule. According to a preferable updating rule, a next modified target value candidate is determined by means of a combination of a direction of a change in an evaluation value of a current modified target value candidate relative to an evaluation value of a previous modified target value candidate and a direction of change in the current modified target value candidate relative to the previous modified target value candidate. Further, if modified target value candidates are being sequentially updated, preferably, if the evaluation value of the current modified target value candidate is a more favorable value than the evaluation value of the previous modified target value candidate, the current modified target value candidate is provisionally determined to be a final modified target value, while if the evaluation value of the current modified target value candidate is not a more favorable value than the evaluation value of the previous modified target value candidate, a final modified target value that is provisionally determined at a previous time is maintained as it is.

### BRIEF DESCRIPTION OF DRAWINGS

FIG. 1 is a view illustrating the configuration of an after-treatment system of a diesel engine to which a plant control device according to an embodiment of the present invention is applied.

FIG. 2 is a view illustrating a target value tracking control structure of the plant control device according to an embodiment of the present invention.

FIG. 3 is a view illustrating a structure obtained by equivalently deforming the target value tracking control structure shown in FIG. 2.

FIG. 4 is a flowchart illustrating an algorithm of a reference governor that is adopted in an embodiment of the present invention.

FIG. 5 is a view illustrating an image of prediction model calculation processing performed by the reference governor that is adopted in an embodiment of the present invention.

FIG. 6 is a view illustrating the setting of a map that is used to calculate an evaluation value by the reference governor that is adopted in an embodiment of the present invention.

FIG. 7 is a view illustrating an image of evaluation value calculation processing performed by the reference governor that is adopted in an embodiment of the present invention.

FIG. 8 is a table that shows specific rules for updating of a modified target value candidate by the reference governor that is adopted in an embodiment of the present invention.

FIG. 9 is a view illustrating an image of operations of the reference governor that is adopted in an embodiment of the present invention.

### DESCRIPTION OF EMBODIMENTS

An embodiment of the present invention will be described hereunder using the accompanying drawings.

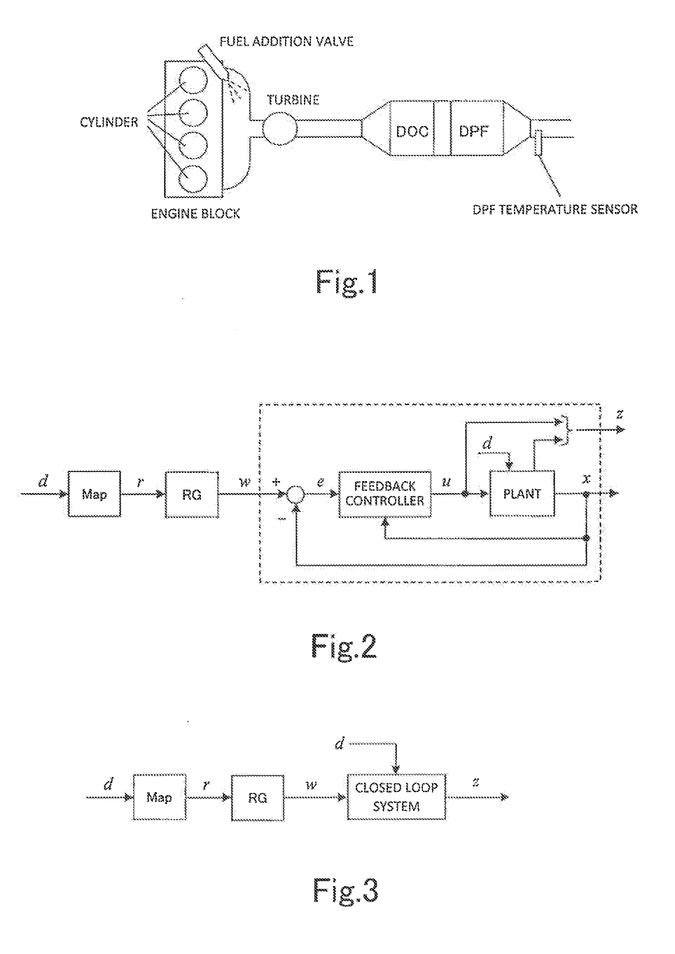

A control device according to the present embodiment is a control device that takes a diesel engine that is mounted in a vehicle, more specifically, an after-treatment system of a diesel engine, as a plant that is a control object. FIG. 1 is a schematic diagram illustrating the configuration of an after-treatment system of a diesel engine. The after-treatment system includes a DOC (diesel oxidation catalyst) and a DPF (diesel particulate filter) in an exhaust passage, and a fuel addition valve in an exhaust port of a cylinder head. A temperature sensor for measuring a DPF temperature (more specifically, the outlet gas temperature of the DPF) that is a control output of the after-treatment system is mounted downstream of the DPF in the exhaust passage.

The control device according to the present embodiment has a control structure for causing the DPF temperature to track a target value while satisfying respective constraints imposed on the DPF temperature. The control structure is a target value tracking control structure shown in FIG. 2. The target value tracking control structure according to the present embodiment includes a target value map (Map), a reference governor (RG) and a feedback controller.

When the target value map receives input of an exogenous input d that indicates an operating condition of the plant which is the control object, the target value map outputs a target value r of the DPF temperature as a control output. The exogenous input d includes a mass flow rate of exhaust gas and an atmospheric temperature and the like. These physical quantities which are included in the exogenous input d may be measured values or estimated values.

Upon receiving input of the target value r of the DPF temperature, the reference governor modifies the target value r so that constraints imposed on the DPF temperature are satisfied, and outputs a modified target value w of the DPF temperature. Reference character z in FIG. 2 denotes a specific state quantity on which a constraint is imposed among the state quantities that includes a control input and a control output. In this case, it is assumed that the specific state quantity z on which there is a constraint means the DPF temperature that is a control output. An upper limit value is set as a constraint for the DPF temperature. If the DPF temperature rises continuously there is a risk that it will lead to erosion of the DPF. The upper limit value that is set as a constraint is set to a value that can prevent erosion and ensure the reliability of the DPF.

Upon receiving input of the modified target value w of the DPF temperature from the reference governor, the feedback controller acquires a state quantity x that indicates the present value of the DPF temperature, and determines a control input u to be provided to the plant that is the control object by feedback control based on a deviation e between the modified target value w and the state quantity x. Since the plant that is the control object according to the present embodiment is an after-treatment system, a fuel amount to be added to exhaust gas by a fuel addition valve, that is, a fuel addition amount, is used as the control input u. The technical specifications of the feedback controller are not limited, and a known feedback controller can be used. For example, it is possible to use a proportional-integral feedback controller.

FIG. 3 is a view illustrating a feed-forward structure obtained by equivalently deforming the target value tracking control structure shown in FIG. 2. The closed loop system surrounded by a dashed line in FIG. 2 is taken as a single model in the feed-forward structure shown in FIG. 3, on the basis that the closed loop system has already been designed. A model of the closed loop system is expressed by the following model expression (1). In expression (1), f and g represent functions of the model expression. Further, k represents a discrete time point that corresponds to a sampling time of the closed loop system.

$$\begin{matrix}[ Expression 1 ] & \\ P : \{ \begin{matrix}x ( k + 1 ) = f ( x ( k ) , w ( k ) , d ( k ) ) \\ z ( k ) = g ( x ( k ) , w ( k ) , d ( k ) )\end{matrix} & ( 1 )\end{matrix}$$

The reference governor operates in accordance with a programmed algorithm. According to this algorithm, the reference governor determines candidates for the modified target value w based on the received target value r. The reference governor then inputs the exogenous input d and the respective modified target value candidates into a prediction model represented by the above described expression (1), and calculates future predicted values of the DPF temperature. The reference governor calculates predicted values of the DPF temperature across a predetermined prediction horizon and, for each of the modified target value candidates, determines whether or not the predicted value of the DPF temperature conflicts with the constraint, that is, whether or not the predicted value exceeds the upper limit value of the DPF temperature. The reference governor then determines a modified target value candidate that is nearest to the original target value r within a range in which the predicted value does not conflict with the constraint to be a final modified target value w.

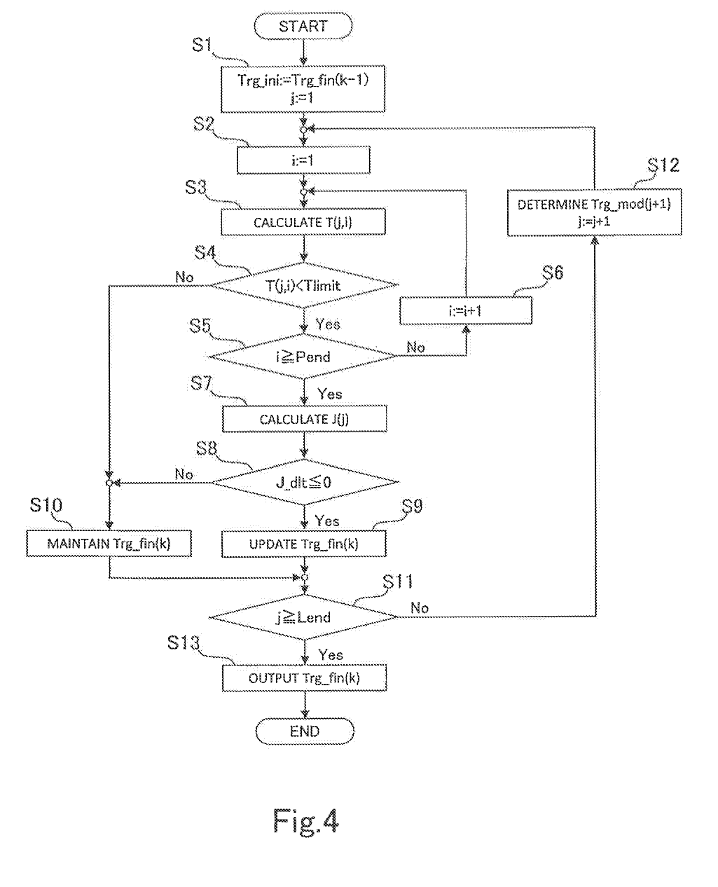

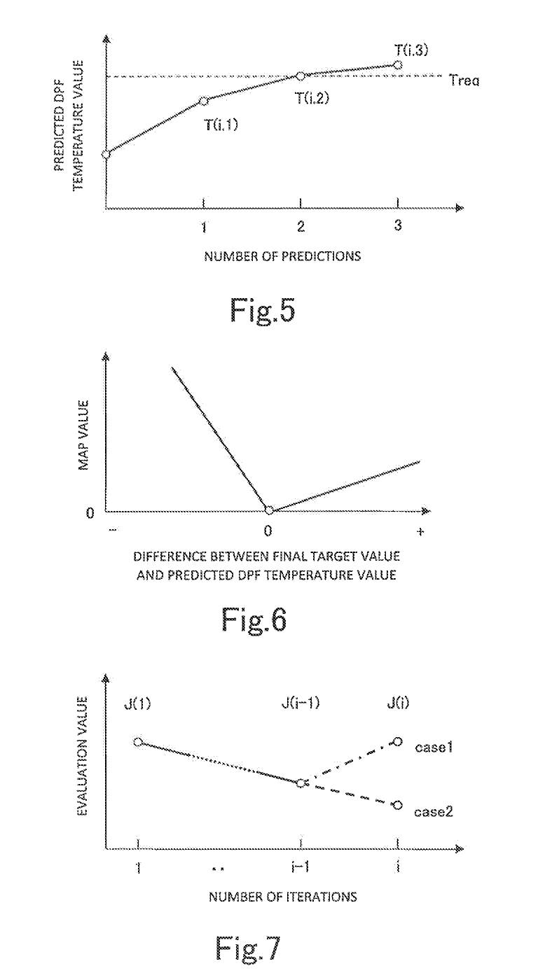

The reference governor algorithm can be described in more detail by means of a flowchart shown in FIG. 4 and the accompanying explanatory drawings of FIG. 5 to FIG. 9. Hereunder, the details of the reference governor algorithm are described in accordance with the flowchart illustrated in FIG. 4.

The reference governor algorithm illustrated in the flowchart in FIG. 4 is repeatedly executed at each sampling time of the closed loop system. In step S1, a modified target value candidate of the DPF temperature is initialized. A modified target value Trg_fin(k−1) output at a previous discrete time point k−1 is used as an initial value Trg_ini of the modified target value candidate. Further, in step S1, the number of times a search for a modified target value candidate is iteratively performed (number of iterations) j is initialized to an initial value of 1. Note that, hereunder the current modified target value candidate, that is, the modified target value candidate with respect to the number of iterations j, is represented by “Trg_mod(j)”.

In step S2, a number of predictions i with respect to prediction of the DPF temperature using the prediction model is initialized to an initial value of 1. Note that, the number of predictions i refers to a discrete time point that corresponds to a prediction cycle of the reference governor, and a period from a discrete time point corresponding to i=1 to a discrete time point corresponding to i=Pend is the prediction horizon. The term “Pend” represents a target number of predictions, and corresponds to the final discrete time point of the prediction horizon.

In step S3, prediction model calculation processing, that is, calculation of a predicted value of the DPF temperature using the prediction model is performed.

According to the prediction model calculation processing, a predicted value T(j,i) of the DPF temperature at the number of predictions i is calculated using the prediction model based on the current modified target value candidate Trg_mod(j) for the DPF temperature. Note that, an interval between the discrete time points of the prediction model, that is, the prediction cycle, can be arbitrarily set. FIG. 5 is a view illustrating an image of the prediction model calculation processing, and illustrates an example in which calculation of a predicted DPF temperature value was executed three times in a case where the prediction cycle was set at two seconds. Note that, a straight line that is drawn along with a polygonal line of the predicted DPF temperature value in FIG. 5 is a straight line indicating the original target value (final target value) Treq of the DPF temperature.

In step S4, a determination is performed with respect to a reliability requirement of the DPF. The term “reliability requirement” refers to the requirement that the DPF temperature is not equal to or greater than an upper limit value that is a constraint. The predicted DPF temperature value T(j,i) calculated in step S3 and an upper limit value Tlimit are compared, and if the predicted DPF temperature value T(j,i) is less than the upper limit value Tlimit it is determined that the predicted DPF temperature value T(j,i) is not conflicting with the constraint, that is, the reliability requirement is satisfied.

If the reliability requirement is satisfied, the processing proceeds to step S5. In step S5 it is determined whether or not the number of predictions i has reached the target number of predictions Pend.

If the number of predictions i is less than the target number of predictions Pend, the processing proceeds to step S6. In step S6, the number of predictions i is incremented. Thereafter, the processing proceeds to step S3 again, and a predicted value T(j,i) of the DPF temperature for the current number of predictions i is calculated using the prediction model. The processing from step S3 to step S6 is then repeatedly executed until the number of predictions i reaches the target number of predictions Pend.

When the number of predictions i reaches the target number of predictions Pend, the processing proceeds to step S7. In step S7, an evaluation function calculation, that is, calculation of an evaluation value J(j) of the current modified target value candidate Trg_mod(j), is performed using a previously defined evaluation function. The most favorable value for the evaluation value J(j) is zero, and the larger that the evaluation value J(j) becomes, the lower the evaluation of the modified target value candidate Trg_mod(j) is. The evaluation function that gives the evaluation value J(j) is represented specifically by the following expression (2). The term “map[Treq−T(j,i)]” in expression (2) is a map value that is determined from a map that takes a deviation between a final target value Treq and the predicted DPF temperature value T(j,i) as an argument.

$$\begin{matrix}[ Expression 2 ] & \\ J ( j ) = {\sum }_{i = 1}^{Pend} map [ Treq - T ( j , i ) ] & ( 2 )\end{matrix}$$

FIG. 6 illustrates the setting of a map that is used to calculate the evaluation value J(j). The nearer that the predicted DPF temperature value T(j,i) is to the final target value Treq, the more favorable the predicted DPF temperature value T(j,i) is, and it is also desirable that the predicted DPF temperature value T(j,i) does not exceed the final target value Treq. Therefore, the map shown in FIG. 6 is set so that a map value when the predicted DPF temperature value T(j,i) matches the final target value Treq is zero, and the map values increase as the predicted DPF temperature value T(j,i) moves away from the final target value Treq. Further, this map is set so that an increment of the map value with respect to an increment in the difference between the predicted DPF temperature value T(j,i) and the final target value Treq is larger in a case where the predicted DPF temperature value T(j,i) is greater than the final target value Treq than in a case where the predicted DPF temperature value T(j,i) is less than the final target value Treq.

In steps S8 to S10, updating of a modified target value Trg_fin(k) to be output at a discrete time point k is performed. First, in step S8, as shown in the following expression (3), a deviation J_dlt between the evaluation value J(j) of the modified target value candidate Trg_mod(j) that was calculated the current time and an evaluation value J(j−1) of a modified target value candidate Trg_mod(j−1) with respect to a number of iterations j−1 is calculated. It is then determined whether or not the deviation J_dlt is equal to or less than zero.

[Expression 3]

J_{—}dlt=J(J)−J(j−1) (3)

FIG. 7 is a view illustrating an image of the evaluation value calculation processing, and shows an example in which an evaluation value varies according to the number of iterations. In a case where the current evaluation value J(i) is larger than the previous evaluation value J(j−1), such as in case 1 in FIG. 7, the deviation J_dlt is greater than zero. The fact that the deviation J_dlt is greater than zero means that the evaluation for the previous modified target value candidate Trg_mod(j−1) is higher than the evaluation for the current modified target value candidate Trg_mod(j). In contrast, in a case where the current evaluation value J(j) is smaller than the previous evaluation value J(j−1), such as in case 2, the deviation J_dlt is less than zero. The fact that the deviation J_dlt is less than or equal to zero means that the evaluation for the current modified target value candidate Trg_mod(j) is higher than the evaluation for the previous modified target value candidate Trg_mod(j−1).

If the deviation J_dlt is less than or equal to zero, the processing proceeds to step S9. In step S9, the currently set modified target value candidate Trg_mod(j) is provisionally determined to be a final modified target value Trg_fin(k). By updating the value of the modified target value Trg_fin(k) to the modified target value candidate that has the higher evaluation, the modified target value Trg_fin(k) approaches the final target value Treq.

If the deviation J_dlt is greater than zero, the processing proceeds to step S10. In step S10, the value of the modified target value Trg_fin(k) to be output is maintained as it is as the value that was provisionally determined the previous time. That is, the modified target value candidate that has been nearest to the final target value Treq up to the present time is maintained as it is as the final modified target value Trg_fin(k).

Further, if it is determined in step S4 that the reliability requirement is not satisfied, the processing from step S5 to step S8 is skipped and the processing proceeds directly to step S10. That is, if the predicted DPF temperature value T(j,i) reaches the upper limit value Tlimit, the prediction model calculation based on the current modified target value candidate Trg_mod(j) is immediately aborted. In such case, calculation of a predicted DPF temperature value at the remaining discrete time points, that is, the discrete time points from a number of predictions i+1 to the target number of predictions Pend, is cancelled. Further, the current modified target value candidate Trg_mod(j) is excluded from the candidates for the final modified target value Trg_fin(k), and in step S10 the value of the modified target value Trg_fin(k) is maintained as it is at the value that was provisionally determined the previous time. A modified target value candidate that causes the DPF temperature to conflict with the constraint is not appropriate as a final modified target value. Hence, no disadvantage arises even if prediction model calculations relating to the relevant modified target value candidate are aborted during the course of the processing, and in fact the computational load of the control device can be reduced as a result.

After step S9 or step S10, the processing proceeds to step S11. In step S1, it is determined whether or not the number of iterations j has reached a scheduled number of iterations Lend that was previously set.

If the number of iterations j is less than the scheduled number of iterations Lend, the processing proceeds to step S12. In step S12, a modified target value candidate Trg_mod(j+1) for the next number of iterations j+1 is determined. That is, updating of the modified target value candidate to be used for the prediction model calculation is performed. According to the present algorithm, fundamentally the next modified target value candidate Trg_mod(j+1) is determined by means of a combination of the direction of a change in the evaluation value J(j) of the current modified target value candidate Trg_mod(j) relative to the evaluation value J(j−1) of the previous modified target value candidate Trg_mod(j−1) and the direction of a change in the current modified target value candidate Trg_mod(j) relative to the previous modified target value candidate Trg_mod(j−1).

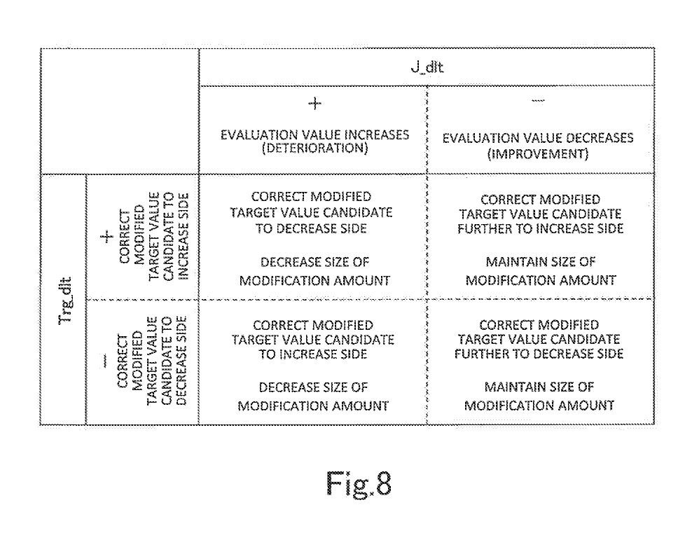

FIG. 8 is a table that shows specific rules for updating a modified target value candidate. As shown in the following expression (4), Trg_dlt in the table shown in FIG. 8 is calculated as a deviation between the current modified target value candidate Trg_mod(j) and the previous modified target value candidate Trg_mod(j−1). If the modified target value candidate Trg_mod(j) is updated to an increase side relative to the previous time, the deviation Trg_dlt will be greater than zero, while if the modified target value candidate Trg_mod(j) is updated to a decrease side relative to the previous time, the deviation Trg_dlt will be less than zero.

[Expression 4]

Trg_{—}dlt=Trg_mod(j)−Trg_mod(j−1) (4)

According to the table shown in FIG. 8, in a case where the deviation Trg_dlt is a positive value and the deviation J_dlt is a negative value, that is, in a case where the evaluation value became more favorable than the previous time as a result of the modified target value candidate Trg_mod(j) being corrected to the increase side relative to the previous time, the next modified target value candidate Trg_mod(j+1) is corrected further to the increase side relative to the current value. That is, a value obtained by adding a modification amount mod(j+1) that is a positive value to the current modified target value candidate Trg_mod(j) is set as the next modified target value candidate Trg_mod(j+1). The size of the next modification amount mod(j+1) is set to the same size as the current modification amount mod(j). Note that, the initial value of the modification amount is set to a value that is obtained by multiplying a deviation between the final target value Treq and the initial value Trg_ini of the modified target value candidate by a predetermined coefficient that is less than or equal to 1.

On the other hand, in a case where the deviation Trg_dlt is a positive value and the deviation J_dlt is a positive value, that is, in a case where the evaluation value became less favorable than the previous time as a result of the modified target value candidate Trg_mod(j) being corrected to the increase side relative to the previous time, the next modified target value candidate Trg_mod(j+1) is corrected to the decrease side relative to the current value. That is, a value obtained by adding a modification amount mod(j+1) that is a negative value to the current modified target value candidate Trg_mod(j) is set as the next modified target value candidate Trg_mod(j+1). The size of the next modification amount mod(j+1) is set to a size that is obtained by multiplying the size of the current modification amount mod(j) by a predetermined coefficient that is less than 1. That is, although the size of the modification amount mod(j+1) is maintained in a case where the correction directions are the same direction, the size of the modification amount mod(j+1) is decreased in the case of modifying the correction direction in the opposite direction.

In a case where the deviation Trg_dlt is a negative value and the deviation J_dlt is a negative value, that is, in a case where the evaluation value became more favorable than the previous time as a result of the modified target value candidate Trg_mod(j) being corrected to the decrease side relative to the previous time, the next modified target value candidate Trg_mod(j+1) is corrected further to the decrease side relative to the current value. That is, a value obtained by adding a modification amount mod(j+1) that is a negative value to the current modified target value candidate Trg_mod(j) is set as the next modified target value candidate Trg_mod(j+1). The size of the next modification amount mod(j+1) is set to the same size as the current modification amount mod(j).

In a case where the deviation Trg_dlt is a negative value and the deviation J_dlt is a positive value, that is, in a case where the evaluation value became less favorable than the previous time as a result of the modified target value candidate Trg_mod(j) being corrected to the decrease side relative to the previous time, the next modified target value candidate Trg_mod(j+1) is corrected to the increase side relative to the current value. That is, a value obtained by adding a modification amount mod(j+1) that is a positive value to the current modified target value candidate Trg_mod(j) is set as the next modified target value candidate Trg_mod(j+1). The size of the next modification amount mod(j+1) is set to a size that is obtained by multiplying the size of the current modification amount mod(j) by a predetermined coefficient that is less than 1.

An exception to the above described updating rules is a case where the processing proceeds directly from step S4 to step S10 because the predicted DPF temperature value T(j,i) at a certain number of predictions i has reached the upper limit value Tlimit. In this case, the next modified target value candidate Trg_mod(j+1) is corrected to the decrease side relative to the current value. That is, the next modification amount mod(j+1) is a negative value, and the size thereof is set to a size that is obtained by multiplying the size of the current modification amount mod(j) by a predetermined coefficient that is less than 1. Further, in this case, the evaluation value J(j) of the current modified target value candidate Trg_mod(j) is defined as a maximum value Jmax for the purpose of ensuring the consistency of calculations in the next update processing.

In step S12, after updating of the modified target value candidate was performed as described above, the number of iterations j is incremented. The processing then proceeds to step S2 again, and the number of predictions i for the DPF temperature using the prediction model is initialized to the initial value of 1. The processing from step S2 to step S12 is then repeatedly executed until the number of iterations j reaches the scheduled number of iterations Lend.

When the number of iterations j reaches the scheduled number of iterations Lend, the processing proceeds to step S13. In step S13, the modified target value Trg_fin(k) that had been provisionally determined is formally determined to be the final modified target value and is output to the feedback controller. Thus, the modified target value determination processing at the current discrete time point k is completed. The modified target value Trg_fin(k) that is output this time is used as the initial value Trg_ini of the modified target value candidate at the next discrete time point k+1.

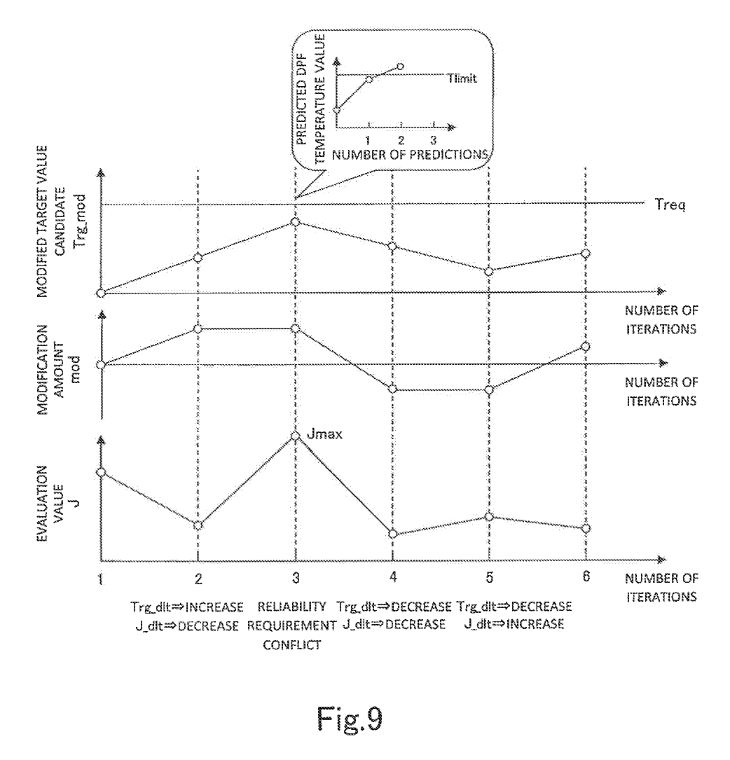

FIG. 9 is a view illustrating an image of operations of the reference governor that are achieved by means of the above described algorithm. An upper portion in FIG. 9 shows variations depending on the number of iterations in the modified target value candidate Trg_mod, a middle portion in FIG. 9 shows variations depending on the number of iterations in the modification amount mod, and a lower portion in FIG. 9 shows variations depending on the number of iterations in the evaluation value J. A modified target value candidate Trg_mod(l) that is set when the number of iterations is 1 is an initial value, and is set to a value of the modified target value Trg_fin that was output the previous time. The modification amount mod(2) that is set when the number of iterations is 2 is an initial value, and is set to a value obtained by multiplying a deviation between the final target value Treq and the modified target value candidate Trg_mod(l) by a predetermined coefficient that is less than or equal to 1.

In the example illustrated in FIG. 9, when the number of iterations is 2, the modified target value candidate Trg_mod(2) is corrected to the increase side as a result of the modification amount mod(2) that is a positive value being added to the modified target value candidate Trg_mod(1). As a result, in a case where the evaluation value J(2) decreased to a value that is less than the previous value, the modification amount mod(3) when the number of iterations is 3 will be the same value as the modification amount mod(2), and the modified target value candidate Trg_mod(3) will be further corrected to the increase side.

In the example illustrated in FIG. 9, in the prediction model calculation when the number of iterations is 3, a predicted DPF temperature value T(3,2) at the time that the number of predictions is 2 exceeds the upper limit value Tlimit. Therefore, in order to abort the performance of unnecessary prediction model calculations and reduce the computational load of the control device, the prediction model calculation from a number of predictions 3 relating to the modified target value candidate Trg_mod(3) onwards is cancelled, and the evaluation value J(3) is set to the maximum value Jmax. In this case, the modification amount mod(4) when the number of iterations is 4 is changed to a negative value, and the size thereof is reduced to a size that is less than the size of the modification amount mod(3).

As a result of the modification amount mod(4) being made a negative value, the modified target value candidate Trg_mod(4) when the number of iterations is 4 is corrected to the decrease side. Consequently, in a case where the evaluation value J(4) decreased to a value that is less than the previous value, the modification amount mod(5) when the number of iterations is 5 is made the same value as the modification amount mod(4), and the modified target value candidate Trg_mod(5) is further corrected to the decrease side. In a case where an evaluation value J(5) is increased to a value that is greater than the previous value by the above described correction, the modification amount mod(6) when the number of iterations is 6 is changed to a positive value, and the size thereof is made less than the size of the modification amount mod(5). Consequently, the modified target value candidate Trg_mod(6) when the number of iterations is 6 is corrected slightly to the increase side. Thus, the size of the modification amount mod is reduced each time the direction of correcting the modified target value candidate Trg_mod is changed from the increase side to the decrease side or from the decrease side to the increase side. As a result, the modified target value candidate Trg_mod converges towards a certain constant value.

One embodiment of the present invention has been described above. However, the present invention is not limited to the above described embodiment, and various modifications can be made without departing from the spirit and scope of the present invention. For example, the modifications described hereunder can be adopted.

Since a prediction error is included in a prediction model, it is possible that the true DPF temperature will be higher than a DPF temperature that is predicted with a prediction model. Hence, a margin for a prediction error may be provided with respect to the upper limit value of the predicted DPF temperature value to ensure that the DPF temperature does not exceed the upper limit value due to a prediction error. That is, the upper limit value may be set lower in accordance with a prediction error so as to make the constraint stricter by an amount corresponding to a prediction error. Note that, it is known that a prediction error increases as the loop count of the prediction model calculation advances. Hence, setting the upper limit value of the DPF temperature to a progressively lower value in accordance with the number of predictions is a preferable method for preventing a conflict with a constraint.

According to above described algorithm, updating of a modified target value candidate is ended when the number of iterations reaches the scheduled number of iterations. However, a configuration may also be adopted so that, in a case where the prediction model calculation is cancelled due to a conflict with the constraint during the course of the updating process, the number of update operations for the modified target value candidate is increased in accordance with the amount of decrease in the computational load that accompanies cancellation of the calculation. By increasing the number of update operations for the modified target value candidate it is possible to search for a more favorable modified target value and the accuracy of the DPF temperature control can be improved.

According to the above described algorithm, a modified target value candidate is sequentially updated in accordance with updating rules. However, a plurality of modified target value candidates can also be set at one time. For example, a plurality of modified target value candidates may be set at a fixed temperature interval that is based on the original target value. In this case, prediction model calculation processing and evaluation value calculation processing may be executed based on each of the plurality of modified target value candidates, and a final modified target value can be selected from among the plurality of modified target value candidates based on a comparison between the evaluation values.

Although in above described algorithm a constraint is imposed on only the DPF temperature, a configuration may also be adopted in which a constraint is also imposed on another state quantity such as the DOC temperature or the fuel addition amount. In such a case, in step S3, a prediction may be executed across the prediction horizon with respect to all of the specific state quantities on which a constraint is imposed among the state quantities of the plant that is the control object. Thereafter, in step S4, if at least one of the specific state quantities on which a constraint is imposed conflicts with the constraint, the prediction model calculation can be stopped and the remaining calculation operations can be cancelled.

The evaluation function used in the above described algorithm is merely one example. Preferably, an evaluation function is used that gives a more favorable evaluation value as a difference decreases between the original target value and the predicted value of the DPF temperature at the respective discrete time points calculated by the prediction model calculation processing. According to the above described algorithm, since determination of a conflict with respect to the constraint is performed separately in step S3, for example, design of an evaluation function that takes a constraint into consideration, such as in the case of the penalty method, need not be performed. Further, according to the above described algorithm, since a modified target value candidate with respect to which a conflict with the constraint can arise is reliably excluded from the candidates for the final modified target value, a conflict with the constraint can be prevented more reliably compared to a case of adopting the penalty method or the like.

In the above described embodiment, the plant control device according to the present invention is applied to an after-treatment system of a diesel engine. However, the plant control device according to the present invention can also adopt a diesel engine body as a plant that is the control object. In a case where the plant that is the control object is a diesel engine body, the degree of opening of a variable nozzle can be adopted as a control input, and a supercharging pressure can be adopted as a control output. That is, the present invention can be applied to supercharging pressure control of a diesel engine. Further, the degree of opening of an EGR valve can be adopted as a control input, and an EGR rate can be adopted as a control output. That is, the present invention can also be applied to EGR control of a diesel engine. In addition, the degree of opening of a variable nozzle, the degree of opening of an EGR valve and the degree of opening of a diesel throttle can be adopted as control inputs, and a supercharging pressure and an EGR rate can be adopted as control outputs. That is, the present invention can also be applied to coordinated control of a supercharging pressure and an EGR rate in a diesel engine.

In addition, a plant to which the plant control device according to the present invention is applied is not limited to only a diesel engine. For example, the plant control device according to the present invention can also be applied to another vehicle-mounted power plant such as a gasoline engine or a hybrid system, and also to a fuel cell system. Furthermore, as long as the relevant plant can perform control using a reference governor and a feedback controller, the plant control device according to the present invention can be applied to a wide range of plants that also includes stationary plants.

1. A plant control device, comprising:
a feedback controller that determines a control input of a plant by feedback control so that a control output of the plant approaches a target value, and
a reference governor that modifies the target value that is provided to the feedback controller, wherein:
the reference governor is configured to execute:
prediction model calculation processing for sequentially calculating, across a finite prediction horizon, predicted values of state quantities of the plant that include a specific state quantity on which a constraint is imposed, using a prediction model in which a closed loop system including the plant and the feedback controller is modelled, based on a modified target value candidate of the control output,
evaluation function calculation processing for calculating an evaluation value of the modified target value candidate using a previously defined evaluation function based on a calculation result obtained by the prediction model calculation processing, and
modified target value determination processing for executing the prediction model calculation processing and the evaluation function calculation processing with respect to a plurality of modified target value candidates, and determining a final modified target value based on respective evaluation values of the plurality of modified target value candidates; and
in a case where a predicted value of the specific state quantity that is predicted by prediction model calculation processing that relates to a certain modified target value candidate conflicts with a constraint, the reference governor excludes the certain modified target value candidate from candidates for the final modified target value.

2. The plant control device according to claim 1, wherein, in a case where a predicted value of the specific state quantity conflicts with a constraint during performance of prediction model calculation processing relating to a certain modified target value candidate, the reference governor cancels remaining calculations of the prediction model calculation processing relating to the certain modified target value candidate.

3. The plant control device according to claim 2, wherein:
in the prediction model calculation processing, the reference governor calculates a predicted value of the state quantity discretely at a prediction cycle that is previously set, and
in a case where a predicted value of the specific state quantity conflicts with a constraint at a discrete time point during a period from an initial discrete time point until a final discrete time point in prediction model calculation processing relating to a certain modified target value candidate, the reference governor cancels calculations of a predicted value of the state quantity at remaining discrete time points.

4. The plant control device according to claim 3, wherein the reference governor changes a threshold value for determining whether or not a predicted value of the specific state quantity conflicts with a constraint to a stricter value as discrete time points relating to the prediction model calculation processing proceed.

5. The plant control device according to claim 3, wherein:
in the evaluation function calculation processing, the reference governor uses an evaluation function that gives a progressively favorable evaluation value as a difference between a predicted value of the control output at respective discrete time points calculated by the prediction model calculation processing and an original target value of the control output decreases; and
in the modified target value determination processing, the reference governor determines a modified target value candidate for which the evaluation value is a most favorable value to be the final modified target value.

6. The plant control device according to claim 1, wherein:
in the modified target value determination processing, the reference governor updates the modified target value candidate in accordance with a previously defined updating rule; and
according to the updating rule, a next modified target value candidate is determined by means of a combination of a direction of a change in an evaluation value of a current modified target value candidate relative to an evaluation value of a previous modified target value candidate and a direction of a change in the current modified target value candidate relative to the previous modified target value candidate.

7. The plant control device according to claim 6, wherein, in the modified target value determination processing, if the evaluation value of the current modified target value candidate is a more favorable value than the evaluation value of the previous modified target value candidate, the reference governor provisionally determines the current modified target value candidate to be a final modified target value, and if the evaluation value of the current modified target value candidate is not a more favorable value than the evaluation value of the previous modified target value candidate, the reference governor maintains a final modified target value that is provisionally determined at a previous time as it is.

8. The plant control device according to claim 6, wherein in a case where remaining calculations are cancelled during performance of the prediction model calculation processing due to a conflict with a constraint, in the modified target value determination processing the reference governor increases a number of update operations for the modified target value candidate in accordance with an amount of a decrease in a computational load that accompanies cancellation of the calculations.
